(19) United States
(12) Patent Application Publication
(10) Pub. No.: US 2024/0419092 A1
(43) Pub. Date: Dec. 19, 2024

(54) ELECTROPHOTOGRAPHIC PHOTORECEPTOR, PROCESS CARTRIDGE AND IMAGE-FORMING APPARATUS INCLUDING ELECTROPHOTOGRAPHIC PHOTORECEPTOR

(71) Applicant: SHARP KABUSHIKI KAISHA, Sakai City (JP)

(72) Inventors: Midori MORISHITA, Sakai City (JP); Kohichi TORIYAMA, Sakai City (JP); Akiko KIHARA, Sakai City (JP)

(21) Appl. No.: 18/742,587

(22) Filed: Jun. 13, 2024

(30) Foreign Application Priority Data
Jun. 13, 2023 (JP) 2023-097106

(51) Int. Cl. G03G 5/06; G03G 5/047; G03G 5/05; G03G 21/18

(52) U.S. Cl. CPC G03G 5/0631; G03G 5/047; G03G 5/0507; G03G 21/1814

(57) ABSTRACT

An electrophotographic photoreceptor comprising at least a photoreceptive layer on a conductive base, wherein the photoreceptive layer contains a silica filler and a specific electron transporting substance represented by general formula (I) of FIG. 3 and wherein when a content of the silica filler to a total solid content of the photoreceptive layer is denoted by w (% by mass), when an average primary particle diameter of the silica filler is denoted by d (nm), and when a content of the electron transporting substance to the total solid content of the photoreceptive layer is denoted by x (% by mass), the electrophotographic photoreceptor satisfies the following relationship: 0.12<w/(d×x)<0.54.

### BACKGROUND OF THE INVENTION

### Field of the Invention

The present disclosure relates to an electrophotographic photoreceptor, and relates to a process cartridge and an image-forming apparatus that include the electrophotographic photoreceptor.

### Description of the Background Art

Electrophotographic image-forming apparatuses (electrophotographic devices), which form images using electrophotographic technology, are widely used in copiers, printers, facsimile machines, and others.

An electrophotographic photoreceptor (hereinafter also referred to as a “photoreceptor”) used in this electrophotographic process is configured to comprise a photoreceptive layer containing a photoconductive material on a substrate; and as this electrophotographic photoreceptor, a photoreceptor having a photoreceptive layer containing an organic photoconductive material as a main ingredient (also called an “organic photoreceptor”) is widely used.

One drawback of the photoreceptor is light resistance. Although the photoreceptor is not exposed to external light, such as fluorescent lamps, during normal use, the photoreceptor is exposed to external light during maintenance of parts, such as replacing the photoreceptor and its peripheral components or when paper is removed from the apparatus due to a paper jam. If being exposed to external light, the photoreceptor could be severely damaged, which may cause problems with an image.

To overcome this drawback, the addition of a specific electron transporting material (ETM) to the photoreceptive layer has been proposed.

### SUMMARY OF THE INVENTION

In all of the above prior art, if an electron transporting substance is added to the photoreceptive layer in an amount that provides sufficient light resistance, the electron transporting substance itself becomes a trap, resulting in problems such as deterioration of electrical potential stability after repeated use and insufficient abrasion resistance (wear resistance) due to an increase in a proportion of low molecular weight ingredients in the photoreceptive layer.

An object of the present disclosure is to provide an electrophotographic photoreceptor having excellent light resistance and abrasion resistance, preventing deterioration of electric properties during repeated use, and continuously providing good image quality, and also to provide a process cartridge and an image-forming apparatus that include the electrophotographic photoreceptor.

As a result of diligent studies to solve the above problems, the inventors of the present invention have found that a photoreceptive layer can solve the problems that contains an electron transporting substance having a specific structure and a silica filler. This finding has led to the completion of the present invention.

The present disclosure provides an electrophotographic photoreceptor comprising at least a photoreceptive layer on a conductive base, wherein the photoreceptive layer contains a silica filler and an electron transporting substance represented by general formula (I) of FIG. 3
wherein Rₐ and R_{b} are identically or independently a hydrogen atom, a halogen atom, a cyano group, a nitro group, a hydroxyl group, an alkyl group having 1 to 12 carbon atoms, an alkoxy group having 1 to 12 carbon atoms, an aryl group that may have a substituent, a heterocyclic group that may have a substituent, an ester group, a cycloalkyl group, an aralkyl group that may have a substituent, an allyl group, an amide group, an amino group, an acyl group, an alkenyl group, an alkynyl group, a carboxyl group, a carbonyl group, a carboxylic group, or an alkyl halide group; and the substituents each are a halogen atom, an alkyl group having 1 to 6 carbon atoms, an alkoxy group having 1 to 6 carbon atoms, a hydroxyl group, a cyano group, an amino group, a nitro group, or an alkyl halide group; and
wherein when a content of the silica filler to a total solid content of the photoreceptive layer is denoted by w (% by mass), when an average primary particle diameter of the silica filler is denoted by d (nm), and when a content of the electron transporting substance to the total solid content of the photoreceptive layer is denoted by x (% by mass), the electrophotographic photoreceptor is provided that satisfies the following relationship:

0.12<w/(d×x)<0.54.

The present disclosure provides a process cartridge comprising the above-described electrophotographic photoreceptor and at least one selected from an electrifier for electrifying the electrophotographic photoreceptor, a developer for developing an electrostatic latent image formed by exposure to form a toner image, and a cleaner for removing a toner remaining on the electrophotographic photoreceptor.

The present disclosure provides an image-forming apparatus comprising at least the above-described electrophotographic photoreceptor, an electrifier for electrifying the electrophotographic photoreceptor, an exposer for exposing the electrified electrophotographic photoreceptor to form an electrostatic latent image, a developer for developing the electrostatic latent image to form a toner image, and a transferer for transferring the toner image onto a recording medium.

The present disclosure provides an electrophotographic photoreceptor having excellent light resistance and abrasion resistance, preventing deterioration of electric properties during repeated use, and continuously providing good image quality, and also provides a process cartridge and an image-forming apparatus that include the electrophotographic photoreceptor.

### BRIEF DESCRIPTION OF THE DRAWINGS

FIG. 1 is a diagrammatic cross-sectional view showing a configuration of a main part of a photoreceptor (laminated photoreceptor) 1 according to the present disclosure.

FIG. 2 is a schematic side view showing a configuration of key components of an image-forming apparatus 100 according to the present disclosure.

FIG. 3 is a structural formula represented by general formula (I).

FIG. 4 is a structural formula of compound 1-1.

FIG. 5 is a structural formula of compound 1-2.

FIG. 6 is a structural formula of compound 1-3.

FIG. 7 is a structural formula of compound 1-4.

FIG. 8 is a structural formula represented by general formula (A).

FIG. 9 is a structural formula represented by general formula (II).

FIG. 10 is a structural formula of compound 2-1.

FIG. 11 is a structural formula of compound 2-2.

FIG. 12 is a structural formula of compound 2-3.

FIG. 13 is a structural formula of titanyl phthalocyanine.

FIG. 14 is a Table showing main constituent materials used in the preparation of photoreceptors in Examples and Comparative Examples, their contents, and their relationship.

FIG. 15 is a Table showing evaluation results of the obtained photoreceptors in Examples and Comparative Examples.

### DESCRIPTION OF THE PREFERRED EMBODIMENTS

A photoreceptor according to the present disclosure is an electrophotographic photoreceptor comprising at least a photoreceptive layer on a conductive base,
wherein the photoreceptive layer contains a silica filler and an electron transporting substance represented by general formula (I) to be described below,
wherein when a content of the silica filler to a total solid content of the photoreceptive layer is denoted by w (% by mass), when an average primary particle diameter of the silica filler is denoted by d (nm), and when a content of the electron transporting substance to the total solid content of the photoreceptive layer is denoted by x (% by mass), the factors of the electrophotographic photoreceptor satisfy the following relationship: 0.12<w/(d×x)<0.54. The above-mentioned description “a content of the silica filler to a total solid content of the photoreceptive layer” indicates a content of the silica filler with respect to a total solid content in the photoreceptive layer containing the silica filler and the electron transporting substance; and the above-mentioned description “a content of the electron transporting substance to the total solid content of the photoreceptive layer” indicates a content of the electron transporting substance with respect to the total solid content in the photoreceptive layer containing the silica filler and the electron transporting substance. If a photoreceptive layer (to be described below) is a laminated photoreceptive layer comprising a charge generating layer and a charge transporting layer, the description “a content of the silica filler to a total solid content of the photoreceptive layer” indicates a content of the silica filler with respect to a total solid content in the charge transporting layer containing both the silica filler and the electron transporting substance, and the description “a content of the electron transporting substance to the total solid content of the photoreceptive layer” indicates a content of the electron transporting substance with respect to the total solid content in the charge transporting layer containing both the silica filler and the electron transporting substance.

In the present specification, a numerical range “A to B” means “A or more (higher) to B or less (lower)”; for example, if a variable is denoted as x, a numerical range is denoted as “A≤x≤B”.

In the following, constituent features that characterize the photoreceptor according to the present disclosure will be described; and then (1) the photoreceptor, (2) the process cartridge, and (3) the image-forming apparatus will be described.

Embodiments and Examples to be described below are only specific examples of the present invention; and the present invention is not limited thereto.

Relationship between Content of Electron Transporting Substance and Average Primary Particle Diameter and Content of Silica Filler

Damages to the photoreceptor due to external light, such as a fluorescent lamp and an LED, occur when the external light penetrates the charge transporting layer and acts on a charge generating substance to cause charge trapping. If the photoreceptive layer contains a silica filler, memory (charge) is easily generated when the photoreceptive layer is exposed to light from outside, and light resistance tends to deteriorate. Although the cause of this is not known, it is thought that the photoreceptive layer containing microparticles that easily become negatively charged, such as silica, facilitates stabilization of excess carriers generated in the charge generating layer when exposed to light.

In a laminated photoreceptor, the light resistance tends to be even worse. If the charge transporting layer contains a silica filler, a surface area of an interface between the charge transporting layer and the charge generating layer increases. This results in a larger contact area between the charge transporting layer and the charge generating layer, which increases the penetration of a hole transporting substance into the charge generating layer. This disrupts a stacking structure of the charge generating substance, which should normally be arranged in a regular pattern (in orderly sequence). This makes it easier for traps generated when exposed to light to be stabilized without being recombined, resulting in poor light resistance. In the meanwhile, charge exchange between the layers becomes smooth, making it difficult for a residual potential to increase, resulting in good potential stability. The less the average primary particle diameter of the silica filler and the more the silica filler content, the more the contact area increases, with the result that both advantages and disadvantages become more promoted.

The electron transporting substance has a function of effectively blocking an action of light wavelength ingredients of external light on the charge generating substance and a function of accelerating recovery from damages caused by light exposure. In the present disclosure, the electron transporting substance absorbs external light and suppresses the generation of charge traps. When the traps are generated, a function of electron transportability promotes the recombination of the charge traps to facilitate recovery from the damages. The higher the amount of the electron transporting substance added, the better the light resistance; however, the electron transporting substance itself could become a trap and cause deterioration of electric properties.

As described above, the content of the electron transporting substance and the content and the average primary particle diameter of the silica filler each have a significant impact on light resistance and potential stability; therefore, it is important to balance these factors. If the content of the electron transporting substance with respect to the total solid content of the photoreceptive layer is denoted by x (% by mass), if the content of the silica filler with respect to the total solid content of the photoreceptive layer is denoted by w (% by mass), if the average primary particle diameter of the silica filler is denoted by d (nm), and if the relationship 0.12<w/(d×x)<0.54 is met, then a photoreceptor with both excellent light resistance and potential stability during repeated use can be obtained.

If w/(d×x) is 0.12 or less, a w value is too large relative to a (d×x) value, and potential stability may deteriorate. If w/(d×x) is 0.54 or more, a w value is too small relative to a (d×x) value, and desired light resistance and recovery from light damages (photodamage) may not be achieved.

The preferable relationship is 0.15<w/(d×x)<0.50, and more preferably 0.20<w/(d×x)<0.43.

### Electron Transporting Substance

Since commonly-used fluorescent lamps have light wavelength ingredients strong at a wavelength of around 550 nm, these light wavelength ingredients will act on a charge generating material to generate charge traps. Light wavelength ingredients at a wavelength of around 600 nm are used for an LED and laser beams to form an electrostatic latent image by exposing the photoreceptor and are also used for an LED and the like to eliminate surface charges remaining on the photoreceptor. If the light of this wavelength is blocked off, a residual potential will increase; consequently, potential stability cannot be maintained repeatedly. It is thus desirable that the electron transporting substance should have a maximum absorption wavelength Amax within a wavelength range from 515 to 560 nm. More preferably from 525 to 555 nm.

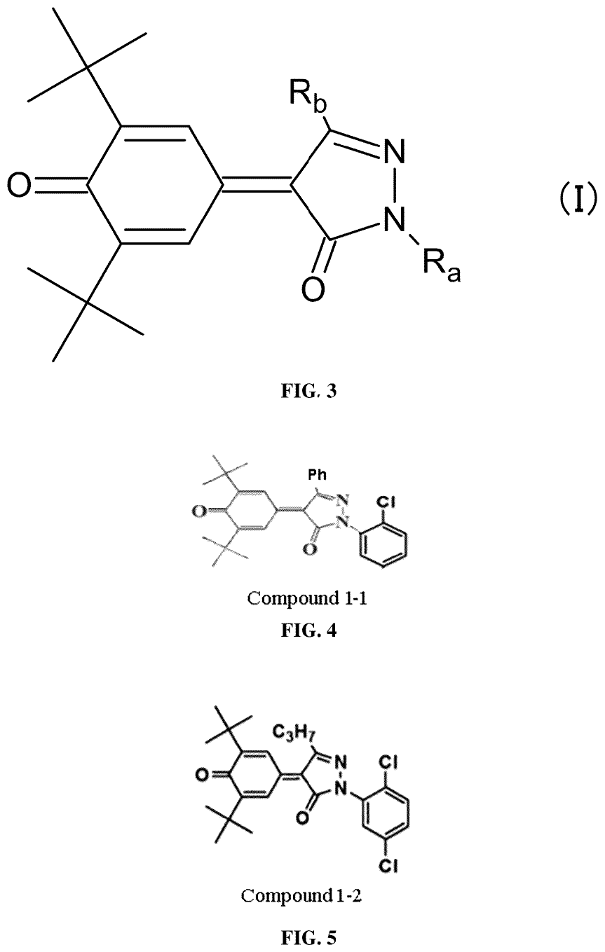

The electron transporting substance according to the present disclosure is represented by general formula (I) of FIG. 3

wherein Rₐ and R_{b} are identically or independently a hydrogen atom, a halogen atom, a cyano group, a nitro group, a hydroxyl group, an alkyl group having 1 to 12 carbon atoms, an alkoxy group having 1 to 12 carbon atoms, an aryl group that may have a substituent, a heterocyclic group that may have a substituent, an ester group, a cycloalkyl group, an aralkyl group that may have a substituent, an allyl group, an amide group, an amino group, an acyl group, an alkenyl group, an alkynyl group, a carboxyl group, a carbonyl group, a carboxylic group, or an alkyl halide group; and the substituents each are a halogen atom, an alkyl group having 1 to 6 carbon atoms, an alkoxy group having 1 to 6 carbon atoms, a hydroxyl group, a cyano group, an amino group, a nitro group, or an alkyl halide group.

The substituents Rₐ and R_{b} in general formula (I) and the substituents that general formula (I) may have will be described.

Examples of the alkyl group may include: alkyl groups having 1 to 6 carbon atoms, such as methyl, ethyl, n-propyl, isopropyl, n-butyl, isobutyl, sec-butyl, tert-butyl, n-pentyl, and n-hexyl; and alkyl groups having 7 to 12 carbon atoms, such as n-heptyl, n-octyl, n-nonyl, n-decyl, n-undecyl, and n-dodecyl.

Examples of the alkoxy group may include: alkoxy groups having 1 to 6 carbon atoms, such as methoxy, ethoxy, n-propoxy, isopropoxy, tert-butoxy, n-pentyloxy, and n-hexyloxy; and alkoxy groups having 7 to 12 carbon atoms, such as n-hexyloxy, n-octyloxy, n-nonyloxy, n-decyloxy, n-undecyloxy, and n-dodecyloxy.

Examples of the aryl group may include phenyl, naphthyl, anthryl, phenanthryl, fluorenyl, biphenylyl, and o-terphenyl.

Examples of the heterocyclic group include pyridyl, indolyl, carbazole, and thiophene. Examples of the cycloalkyl group include cyclopropyl, cyclobutyl, cyclopentyl, cyclohexyl, and cycloheptyl.

Examples of the acyl group include acetyl, propanoyl, and benzyl.

Examples of the aralkyl group include benzyl, phenethyl, benzhydryl, and trityl.

Examples of the alkenyl group include vinyl, propenyl, allyl, butenyl, pentenyl, and hexenyl.

Examples of the alkynyl group include ethynyl, propynyl, butynyl, pentynyl, and hexynyl.

Examples of the carboxylic group include formyl, acetyl, propionyl, butyryl, isobutyryl, valeryl, and isovaleryl.

Examples of the halogen atom include fluorine, chlorine, bromine, and iodine.

In terms of solubility and interactions with resins, the electron transporting substance according to the present disclosure desirably has the following features: The substituents Rₐ and R_{b} in general formula (I) are identically or independently an alkyl group having 1 to 12 carbon atoms or an aryl group that may have a substituent, wherein the substituent is a halogen atom, an alkyl group having 1 to 6 carbon atoms, an alkoxy group having 1 to 6 carbon atoms, a hydroxyl group, a cyano group, an amino group, a nitro group, or an alkyl halide group; the substituent R_{b} is an aryl group that may have a substituent, wherein the substituent is a halogen atom, an alkyl group having 1 to 6 carbon atoms, an alkoxy group having 1 to 6 carbon atoms, a hydroxyl group, a cyano group, an amino group, a nitro group, or an alkyl halide group; and it is particularly desirable that the substituents Rₐ and R_{b} each should be an aryl group that may have a substituent. Examples of the electron transporting substance will be indicated below as compounds 1-1 to 1-4 shown in FIG. 4 to FIG. 7, respectively; and compound 1-1 of FIG. 4 is particularly preferable in terms of mobility and wavelengths of light absorbed.

The content of the electron transporting substance is desirably from 0.65 to 6.5% by mass (mass %) with respect to the total solid content of the photoreceptive layer.

If the content of the electron transporting substance is less than 0.65% by mass, effects such as light resistance and recovery (recoverability) from light damages may not be sufficiently achieved. If the content of the electron transporting substance exceeds 6.5% by mass, the electron transporting substance itself could become a trap and cause deterioration of electric properties of the photoreceptor.

The more preferable content of the electron transporting substance should be from 1.0 to 5.2% by mass, and the further preferable content thereof should be from 1.4 to 3.5% by mass.

### Silica Filler

The term “silica” of the silica filler indicates silicon dioxide (SiO₂).

The silica filler suitably used in the present disclosure should not be limited to its manufacturing method; and examples of the silica filler include: dry process silica such as fumed silica obtained by burning silicon tetrachloride or arc process silica in which silica is microparticulated in a gas phase using high energy such as plasma; precipitation process silica synthesized under alkaline conditions using a sodium silicate solution as a raw material; wet process silica such as gel process silica synthesized under acidic conditions; and sol-gel process silica obtained by hydrolyzing an organosilane compound.

The silica filler may be subjected to a surface treatment with a surface treatment agent to improve the electric properties of the photoreceptor. Examples of the surface treatment agent include hexamethyldisilazane, N-methyl-hexamethyldisilazane, N-ethyl-hexamethyldisilazane, hexamethyl-N-propyldisilazane, dimethyldichlorosilane, and polydimethylsiloxane.

Among these, dimethyldichlorosilane and hexamethyldisilazane are particularly preferable because these agents have good reactivity with a hydroxyl group on a surface of the silica filler and are thus capable of reducing an amount of the hydroxyl group on the silica filler surface, thereby suppressing the degradation of the electric properties of the photoreceptor due to moisture (humidity).

In the present disclosure, the silica filler can be used that is treated with any of the above surface treatment agents; however, a commercially-available silica filler may also be used that is treated with any of the surface treatment agents. Examples of the commercially-available silica filler include: product names such as R972, R972V, R974, R976, RX200, NX130, NX90G, NX90S, NAX50, and RX50, manufactured by NIPPON AEROSIL CO., LTD.; product names such as TS610, TG709F, and TG6110G, manufactured by Cabot Japan K.K.; and a product name such as YA010C, manufactured by ADMATECHS COMPANY LIMITED.

The silica filler desirably has an average primary particle diameter in a range of 10 to 40 nm.

If the average primary particle diameter of the silica filler is less than 10 nm, the silica filler is highly cohesive (agglomerative) and difficult to break up, and its dispersibility may decrease. If the average primary particle diameter of the silica filler exceeds 40 nm, a cohesive structure (agglomeration structure) of the silica filler formed in the photoreceptive layer becomes larger, and problems such as poor cleaning are more likely to occur.

The more preferable average primary particle diameter should be from 12 to 35 nm, and the even more preferable average primary particle diameter should be from 15 to 25 nm.

The average primary particle diameter is a mean value of a particle diameter (long diameter) in the Feret direction calculated by image analysis by magnifying the silica filler by scanning electron microscopy at a magnification from 30,000 to 300,000 times, for example, 100,000 times, and by observing one hundred (100) particles at random as primary particles.

It is desirable that the silica filler should be contained in the photoreceptive layer at a ratio of 7 to 20% by mass (mass %) of the total solid content of the photoreceptive layer.

If the silica filler content is less than 7% by mass of the total solid content of the photoreceptive layer of the photoreceptor, an effect on abrasion resistance may not be obtained sufficiently. If the silica filler content exceeds 20% by mass, the electric properties of the photoreceptor may deteriorate.

The more preferable silica filler content is from 7 to 18% by mass, and especially preferable from 10 to 15% by mass.

The relationship between the content of the silica filler and the average primary particle diameter of the same is important because the less the average primary particle diameter of the silica filler and the higher the silica filler content, the greater the contact area and the worse the light resistance.

It is desirable that the ratio w/d of the content w (% by mass) of the silica filler to the average primary particle diameter d (nm) thereof should be in a range from 0.20 to 0.95.

If w/d is less than 0.20, desired printing durability (printability) may not be obtained, and cleaning defects may occur. If w/d exceeds 0.95, the light resistance may deteriorate because the silica filler content becomes too large relative to the average primary particle diameter of the silica filler.

The more preferable w/d range is from 0.30 to 0.80, and 0.45 to 0.75 is particularly preferable.

Relationship between Electron Transporting Substance and Silica Filler

The smaller the average primary particle diameter of the silica filler, and the higher the silica filler content, the worse the light resistance becomes; therefore, an amount of the electron transporting substance to be added needs to be increased so as to obtain desired light resistance. On the other hand, the larger the average primary particle diameter of the silica filler, and the lower the silica filler content, the better the light resistance becomes; however, potential stability deteriorates, with the result that the amount of the electron transporting substance to be added should be limited.

The ratio w/x of the silica filler content w (%) to the electron transporting substance content x (%) should be desirably in a range from 2.2 to 8.0.

When w/x is lower than 2.2, the content of the electron transporting substance becomes too high in relation to the content of the silica filler, possibly resulting in poor potential stability. When w/x is higher than 8.0, the content of the electron transporting substance becomes too low in relation to the content of the silica filler, with the result that desired light resistance may not be achieved.

The more preferable w/x range is from 2.8 to 7.0, and a range from 3.0 to 6.2 is particularly preferable.

The value obtained by d×x, which would be obtained by multiplying an average primary particle diameter d (nm) of the silica filler by a content x (% by mass) of the electron transporting substance, should be desirably in a range from 20 to 110.

If d×x is less than 20, desired light resistance may not be achieved because the content of the electron transporting substance is too low with respect to the average primary particle diameter of the silica filler. If d×x is more than 110, the content of the electron transporting substance becomes too high with respect to the average primary particle diameter of the silica filler, possibly resulting in poor potential stability.

The more preferable d×x range is from 20 to 90, and the range from 30 to 80 is particularly preferable.

### (1) Electrophotographic Photoreceptor

The photoreceptor according to the present disclosure has at least the photoreceptive layer on the conductive base.

The photoreceptive layer is desirably either a laminated photoreceptive layer formed by laminating a charge generating layer containing a charge generating substance and a charge transporting layer containing a charge transporting substance (a hole transporting substance and an electron transporting substance) in this order or a single-layer photoreceptive layer containing a charge generating substance and a charge transporting substance; and the photoreceptive layer is particularly preferable to be the laminated photoreceptive layer. In a single-layer photoreceptor having the single-layer photoreceptive layer, the charge generating substance is distributed evenly in the photoreceptive layer; therefore, the single-layer photoreceptor is longer in electron transfer distance (electron travel distance) than the laminated photoreceptor having the laminated photoreceptive layer and thus is easily affected by a trapping substance present in the photoreceptive layer. When a photoreceptive layer contains silica as in the photoreceptor according to the present disclosure, the silica becomes a trap; therefore, the laminated photoreceptor is preferable from the viewpoint of electrical characteristics.

In the following, the laminated photoreceptor according to the present disclosure having the laminated photoreceptive layer will be described with reference to the drawings; however, the present invention is not limited to the following descriptions.

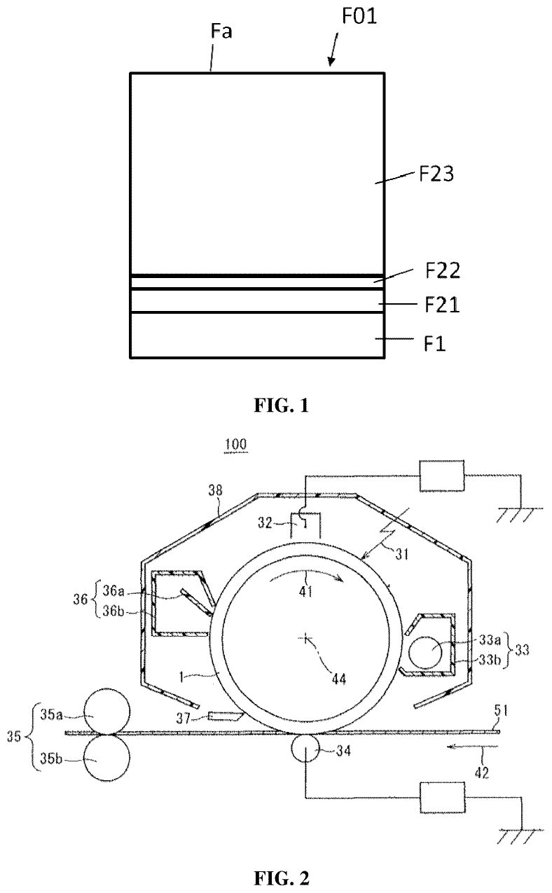

FIG. 1 is a diagrammatic cross-sectional view showing a configuration of a main part of a photoreceptor (laminated photoreceptor) F01 according to the present disclosure. The laminated photoreceptor F01 has a photoreceptive layer comprising: an undercoat layer F21; a charge generating layer F22; and a charge transporting layer F23 stacked in this order on a conductive base F1, the charge generating layer F22 comprising a charge generating substance, and the charge transporting layer F23 comprising a hole transporting substance. In the drawing, Fa indicates a surface of the photoreceptor.

The photoreceptor according to the present disclosure may have a protective layer (surface protective layer) on the photoreceptive layer.

### Conductive Base F1

The conductive base (also called a “conductive substrate” or a “substrate”) has a function as an electrode of the photoreceptor and a function as a supporting member; and constituent materials of the conductive base should not be particularly limited as long as the materials are used in the art.

Specifically, examples of the constituent materials may include: metallic materials such as aluminum, aluminum alloys, copper, zinc, stainless steel, and titanium; polymer materials such as polyethylene terephthalate, nylon, and polystyrene that have a surface treated with metallic foil lamination, metallic vapor deposition, or vapor deposition or coating of a layer of a conductive compound such as a conductive polymer, tin oxide, or indium oxide; hard paper; and glass. Among these materials, aluminum is preferable from the viewpoint of ease of processing; and the aluminum alloys are particularly preferable, such as JIS3003 series, JIS5000 series, and JIS6000 series.

A shape of the conductive base is not limited to a cylindrical shape (drum shape) as shown in FIG. 2, and may be a sheet shape, a columnar shape, an endless belt shape, or the like.

A surface of the conductive base may be treated, as necessary, with anodic oxidation coating, surface treatment with chemicals or hot water, coloring, or irregular reflection treatment such as surface roughening, without affecting image quality, for the purpose of preventing interference fringes, which could be caused by laser beams.

### Undercoat Layer F21

The photoreceptor according to the present disclosure desirably comprises the undercoat layer (also called an “intermediate layer”) disposed between the conductive base and the photoreceptive layer.

The undercoat layer generally coats irregularity on the surface of the conductive base to even out the irregularity to increase film formability of the laminated photoreceptive layer—in this specification, the charge generating layer—and suppresses peeling-off of the laminated photoreceptive layer from the conductive base to improve adhesiveness between the conductive base and the laminated photoreceptive layer. Specifically, it is possible to prevent injection of charges from the conductive base to the laminated photoreceptive layer, to prevent reduction of chargeability of the laminated photoreceptive layer, and to prevent image fogging (a so-called black spot), allowing good electrophotographic characteristics, such as chargeability, to be maintained throughout the life of the photoreceptor.

The undercoat layer can be formed by, for example, dissolving a binder resin in an appropriate solvent to prepare an undercoat layer coating liquid, applying this coating liquid on the surface of the conductive base, and removing the organic solvent by drying.

Examples of the binder resin may include—in addition to a binder resin similar to a binder resin (to be described later) contained in the laminated photoreceptive layer—naturally-occurring polymer materials, such as casein, gelatin, polyvinyl alcohol, and ethyl cellulose.

These binder resins may be used alone or in combination of two or more types.

The binder resin is required to have characteristics, such as not to develop dissolution in or swelling to a solvent used for forming a photoreceptive layer on the undercoat layer, to have excellent adhesiveness to the conductive base, and to have flexibility. Accordingly, among the binder resins described above, a polyamide resin is preferable; and an alcohol-soluble nylon resin is particularly preferable.

Examples of the alcohol-soluble nylon resin may include: a homopolymerized or copolymerized nylon, such as 6-nylon, 66-nylon, 610-nylon, 11-nylon, or 12-nylon; and a chemically-modified nylon resin, such as N-alkoxy methyl-modified nylon.

Examples of the solvent for dissolving or dispersing the binder resin may include: water; alcohols such as methanol, ethanol, and butanol; glymes such as methyl carbitol and butyl carbitol; chlorine-based solvents such as dichloroethane, chloroform, and trichloroethane; acetone; dioxolane; and mixture solvents prepared by mixing two or more types of these solvents. Among these solvents, non-halogen organic solvents are suitably used out of consideration for the global environment.

Also, the undercoat layer coating liquid may contain inorganic compound microparticles. The inorganic compound microparticles in this undercoat layer are blended for a different purpose from inorganic compound microparticles in an outermost layer; however, the former may or may not be the same compound as the latter.

The inorganic compound microparticles can easily modulate a volume resistance value of the undercoat layer and can further suppress injection of charges to the laminated photoreceptive layer and also can maintain the electric properties of the photoreceptor under a variety of environments.

Examples of the inorganic compound microparticles may include microparticles made of titanium oxide, aluminum oxide, aluminum hydroxide, tin oxide, or the like.

The ratio (C/D) between a total mass C of the binder resin and the inorganic compound microparticles and a mass D of the solvent in the undercoat layer coating liquid should be preferably from 1/99 to 40/60 and particularly preferably from 2/98 to 30/70.

The ratio E/F between a mass E of the binder resin and a mass F of the inorganic compound microparticles should be preferably from 90/10 to 1/99 and particularly preferably from 70/30 to 5/95.

To disperse the inorganic compound microparticles in the undercoat layer coating liquid, a known apparatus may be used, such as a ball mill, a sand mill, an attritor, a vibration mill, a sonic disperser, or a paint shaker.

As a method for applying the undercoat layer coating liquid, an optimum method may be appropriately selected in consideration of physical properties and productivity of the coating liquid; and examples of the method may include a spray method, a bar coating method, a roll coating method, a blade method, a ring method, and an immersion coating method.

Among these methods, in the immersion coating method, a substrate is immersed in a coating bath filled with a coating liquid and is then raised at a constant speed or a continuously changing speed to form a layer (film) on a surface of the substrate. This immersion coating method is relatively simple and excellent in productivity and cost, and therefore can be suitably used for manufacturing the photoreceptor. An apparatus used in the immersion coating method may be equipped with a coat liquid disperser typified by an ultrasonic wave generator for the purpose of stabilizing dispersibility of the coating liquid.

The solvent in the coating film may be removed by natural drying, but may be forcibly removed by heating.

A temperature in such a drying step should not be particularly limited as long as the solvent used can be removed; however, the temperature is preferably about 50 to 140° C., and particularly preferably about 80 to 130° C.

If the drying temperature is lower than 50° C., a drying time may be prolonged, and the solvent does not sufficiently evaporate and remains in the photoreceptive layer in some cases. If the drying temperature is higher than about 140° C., the electrical properties of the photoreceptor during repeated use become poor, and an image obtained may deteriorate.

Such temperature conditions are common in formation of not only the undercoat layer but also a layer, such as a laminated photoreceptive layer to be described later, and in other treatments.

If the constituent material of the conductive base is aluminum, a layer containing alumite (alumite layer) can be formed so as to be used as the undercoat layer.

A thickness of the undercoat layer is not particularly limited, but should be preferably from 0.01 to 20 μm, and more preferably from 0.05 to 10 μm.

If the thickness of the undercoat layer is less than 0.01 μm, the layer may not substantially function as an undercoat layer, and may fail to coat defects on the conductive base and to provide an even surface property, and may also fail to prevent injection of charges from the conductive base to the laminated photoreceptive layer. If the thickness of the undercoat layer is more than 20 μm, an even undercoat layer may be less likely to form, and sensitivity of the photoreceptor may also decrease.

### Charge Generating Layer F22

The charge generating layer has a function of generating charges by absorbing irradiated light, such as a semiconductor laser beam, in an image-forming apparatus or the like, and contains a charge generating substance as a main ingredient and, as necessary, contains a binder resin and additives.

As the charge generating substance, a compound used in the art can be used; and specific examples thereof may include azo-based pigments, such as monoazo-based pigments, bisazo-based pigments, and trisazo-based pigments; indigo-based pigments, such as indigo and thioindigo; perylene-based pigments, such as perylene imide and perylene anhydride; polycyclic quinone-based pigments, such as anthraquinone and pyrene quinone; phthalocyanine-based pigments, such as metallic phthalocyanines including titanyl phthalocyanine and metal-free phthalocyanines; organic photoconductive materials, such as squarylium dyes, pyrylium salts, thiopyrylium salts, and triphenylmethane-based dyes; and inorganic photoconductive materials, such as selenium and amorphous silicon; and from which one having sensitivity in an exposure wavelength range can be appropriately selected to be used. These charge generating substances may be used alone or in combination of two or more types.

Among these charge generating substances, a titanyl phthalocyanine represented by general formula (A) of FIG. 8 may be preferably used,

wherein X¹, X², X³, and X⁴ are identically or independently a halogen atom, an alkyl group, or an alkoxy group; and r, s, y, and z are identically or independently an integer of 0 to 4. Titanyl phthalocyanine is a charge generating substance that has high charge generating efficiency and charge injection efficiency in an emission wavelength range (near-infrared light) of laser beams and LED light currently and commonly used, and can generate a large amount of charges by absorbing light, as well as efficiently inject the generated charges into a hole transporting substance without accumulating the charges thereinside.

The titanyl phthalocyanine represented by general formula (A) can be manufactured, for example, by any known manufacture methods, such as a method described in Moser, Frank H. and Arthur L. Thomas. Phthalocyanine Compounds. 1963. New York. Reinhold Publishing Corporation.

Among titanyl phthalocyanine compounds represented by general formula (A), for example, an unsubstituted titanyl phthalocyanine, in which r, s, y, and z are 0, can be obtained by heating and melting phthalonitrile and titanium tetrachloride or heating and reacting them in a suitable solvent, such as a-chloronaphthalene, to synthesize a dichlorotitanyl phthalocyanine, and then hydrolyzing the dichlorotitanyl phthalocyanine with a base or water.

Also, a titanyl phthalocyanine composition can be manufactured by heating and reacting isoindoline with titanium tetraalkoxide, such as tetrabutoxytitanium, in a suitable solvent, such as N-methylpyrrolidone.

Examples of the method for forming the charge generating layer may include: a method for vacuum-depositing the charge generating substance on the conductive base; and a method for applying on the conductive base a charge generating layer coating liquid obtained by dispersing the charge generating substance into a solvent. Of these examples, the following method is preferable: the method for applying on the conductive base a charge generating layer coating liquid obtained by dispersing the charge generating substance by a traditionally known method into a binder resin solution obtained by mixing a binder resin with a solvent. This method will be described below.

The binder resin is not particularly limited and can employ any resin known in the art; and examples of the binder resin may include: resins, such as polyester, polystyrene, polyurethane, phenol resins, alkyd resins, melamine resins, epoxy resins, silicone resins, acrylic resins, methacrylic resins, polycarbonate, polyarylate, polyphenoxy, polyvinyl butyral, and polyvinyl formal; and copolymer resins containing two or more of repeated units constituting these resins.

Examples of the copolymer resins may include insulative resins, such as vinyl chloride-vinyl acetate copolymer resins, vinyl chloride-vinyl acetate-maleic anhydride copolymer resins, and acrylonitrile-styrene copolymer resins. These resins may be used independently, or two or more kinds may be used in combination.

Examples of the solvent may include: halogenated hydrocarbons such as dichloromethane and dichloroethane; ketones such as acetone, methylethylketone, and cyclohexanone; esters such as ethyl acetate and butyl acetate; ethers such as tetrahydrofuran (THF) and dioxane; alkyl ethers of ethylene glycol such as 1,2-dimethoxy ethane; aromatic hydrocarbons such as benzene, toluene, and xylene; and polar aprotic solvents such as N,N-dimethylformamide and N,N-dimethylacetamide. These solvents may be used independently, or two or more kinds may be used in combination.

As for a blending ratio of the charge generating substance to the binder resin, the ratio of the charge generating substance should be desirably in a range of 10 to 99% by mass. If the ratio of the charge generating substance is lower than 10% by mass, sensitivity may decrease. If the ratio of the charge generating substance is higher than 99% by mass, not only film strength of the charge generating layer may decrease, but also dispersibility of the charge generating substance may decrease, leading to an increase of large rough particles, thus reducing surface charges of an area other than an area to be deleted by exposure and generating many image defects, especially image fogs—which are also known as black spots—that are formed when toner adheres to white background and becomes minute black dots.

Before the charge generating substance is dispersed into a binder resin solution, the charge generating substance may be grinded with a grinder in advance. Examples of the grinder used for the grinding may include a ball mill, a sand mill, an attritor, a vibration mill, and a sonic disperser.

Examples of the disperser used for dispersing the charge generating substance into the binder resin solution may include a paint shaker, a ball mill, and a sand mill. As for conditions for this dispersion, it may be necessary to select appropriate conditions for preventing contamination by wear or the like of parts constituting a container or the disperser to be used. Examples of the method for applying the charge generating layer coating liquid include the same methods as the methods for applying the undercoat layer coating liquid, and the immersion coating method is particularly preferable.

A thickness of the charge generating layer is not particularly limited, but should be preferably from 0.05 to 5 μm; and more preferably from 0.1 to 1 μm.

If the thickness of the charge generating layer is less than 0.05 μm, light absorption efficiency may decrease, possibly lowering sensitivity of the photoreceptor. If the thickness of the charge generating layer is more than 5 μm, a charge transfer process inside the charge generating layer comes to a rate-limiting phase in a process of erasing the charges on a surface of the laminated photoreceptive layer, and the sensitivity of the photoreceptor may decrease.

### Charge Transporting Layer F23

The charge transporting layer has a function of receiving charges generated in the charge generating substance and transporting the charges to a surface of the photoreceptor, and contains a hole transporting substance, a binder resin, an electron transporting substance, and a silica filler, and as necessary, additives.

As the hole transporting substance, a compound used in the art can be used.

Examples of the hole transporting substance include carbazole derivatives, pyrene derivatives, oxazole derivatives, oxadiazole derivatives, thiazole derivatives, thiadiazole derivatives, triazole derivatives, imidazole derivatives, imidazolone derivatives, imidazolidine derivatives, bis(imidazolidine) derivatives, styryl compounds, hydrazone compounds, polycyclic aromatic compounds, indole derivatives, pyrazoline derivatives, oxazolone derivatives, benzimidazole derivatives, quinazoline derivatives, benzofuran derivatives, acridine derivatives, phenazine derivatives, aminostilbene derivatives, triarylamine derivatives, triarylmethane derivatives, phenylenediamine derivatives, stilbene derivatives, butadiene derivatives, enamine derivatives, benzidine derivatives, polymers having a group derived from these compounds in a main chain or a side chain (such as poly-N-vinyl carbazole, poly-1-vinyl pyrene, an ethylcarbazole-formaldehyde resin, triphenyl methane polymer, and poly-9-vinyl anthracene), and polysilane. These hole transporting substances may be used alone or in combination of two or more types.

Among these various hole transporting substances, in terms of electric properties, durability, and chemical stability, the stilbene derivatives, the butadiene derivatives, the enamine derivatives, and conjugates of several types of these compounds should be preferable. Above all, the stilbene derivatives are more preferable because of a wavelength of their light absorption ranging from 300 to 480 nm; and stilbene compounds represented by general formula (II) of FIG. 9 are particularly preferable because of their ability to exhibit good electrophotographic characteristics with little increase in residual potential and little deterioration in sensitivity, wherein R¹, R², R³, and R⁶ are identically or independently an alkyl group, an alkoxy group, an aryl group, or an aralkyl group; m, n, p, and q are identically or independently an integer of 0 to 3; and R³ and R⁴ are identically or independently a hydrogen atom or an alkyl group.

The substituents R¹, R², R⁵, and R⁶ in general formula (II) will be described.

Examples of the alkyl group may include alkyl groups having 1 to 6 carbon atoms, such as methyl, ethyl, n-propyl, isopropyl, n-butyl, isobutyl, sec-butyl, tert-butyl, n-pentyl, and n-hexyl.

Examples of the alkoxy group may include alkoxy groups having 1 to 6 carbon atoms, such as methoxy, ethoxy, n-propoxy, isopropoxy, tert-butoxy, n-pentyloxy, and n-hexyloxy. Examples of the aryl group may include phenyl, naphthyl, anthryl, phenanthryl, fluorenyl, biphenylyl, and o-terphenyl.

Examples of the aralkyl group may include benzyl, phenethyl, benzhydryl, and trityl.

m, n, p, and q denoting exponents of the substituents R¹, R², R⁵, and R⁶, respectively, are identically or independently an integer of 0 to 3. If the exponents are 2 or higher, the substituents may be different from each other.

Examples of the alkyl group denoted as the substituents R³ and R⁴ in general formula (II) may include alkyl groups having 1 to 3 carbon atoms, such as methyl, ethyl, n-propyl, and isopropyl.

The stilbene compounds represented by general formula (II) can be synthesized by, for example, a method described in Japanese Patent No. 3272257.

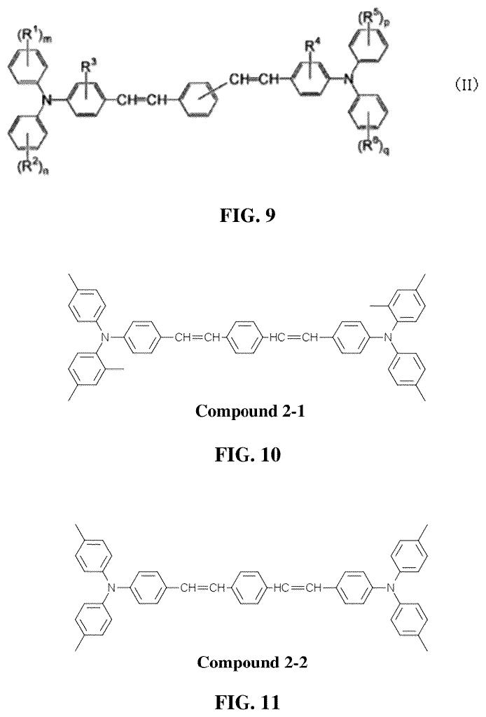

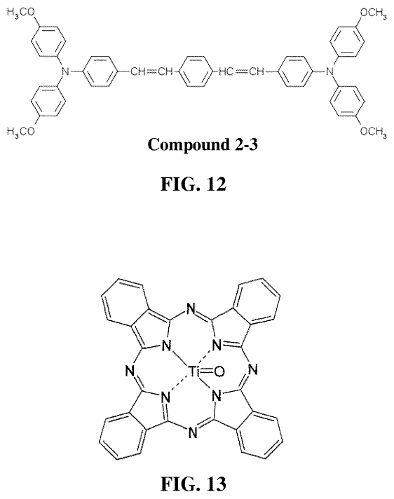

Examples of the stilbene compounds represented by general formula (II) may include compounds 2-1 to 2-3 of FIG. 10 to FIG. 12, respectively; and considering printing durability of the laminated photoreceptive layer, compound 2-1 of FIG. 10 is particularly preferable.

The charge transporting layer is formed desirably as follows: The hole transporting substance is dispersed by a traditionally-known method in a binder resin solution obtained by mixing a binder resin with a solvent; and a charge transporting layer coating liquid is applied on the charge generating layer. This method will be described below.

The binder resin is not particularly limited, and any bindable resin used in the art can be used as the binder resin. Also, the binder resin excellent in compatibility with the hole transporting substance is desirable.

Examples of the binder resin may include: vinyl polymer resins, such as polymethylmethacrylate, polystyrene, and polyvinyl chloride, and copolymer resins thereof; resins, such as polycarbonate, polyester, polyester carbonate, polysulfone, phenoxy resins, epoxy resins, silicone resins, polyarylate, polyamide, polyether, polyurethane, polyacrylamide, phenol resins, and polyphenylene oxide; and thermosetting resins obtained by partially crosslinking these resins. These binder resins may be used alone or in combination of two or more types.

Above all, polystyrene, polycarbonate, polyarylate, and polyphenylene oxide are preferable because these resins are excellent in electric insulation due to a volume resistance value of 10¹³Ω or more and also excellent in film formability, potential characteristics, and the like; and polycarbonate and polyarylate are more preferable, and polycarbonate is particularly preferable.

The charge transporting layer may contain additives, such as an antioxidant, a plasticizer, and a leveling agent, as necessary.

Examples of the antioxidant include tribenzylamine.

Examples of the plasticizer may include: dibasic acid esters, such as phthalic acid esters; fatty acid esters; phosphoric acid esters; chlorinated paraffins; and epoxy-type plasticizers.

Examples of the leveling agent may include silicon-based leveling agents.

Examples of the solvent may include: aromatic hydrocarbons, such as benzene, toluene, xylene, and monochlorobenzene; halogenated hydrocarbons, such as dichloromethane and dichloroethane; ethers, such as tetrahydrofuran, dioxane, and dimethoxy methyl ether; and polar aprotic solvents, such as N,N-dimethylformamide. Also, any of the following solvents may be added as necessary: alcohols, acetonitrile, and methylethylketone. These solvents may be used alone or in combination of two or more types.

Among these solvents, non-halogen organic solvents are suitable to be used out of consideration for the global environment.

The ratio (G/H) between a mass G of the hole transporting substance and a mass H of the binder resin is, for example, desirably of the order of 10/12 to 10/30.

A thickness of the charge transporting layer is not particularly limited, but should be preferably of the order of 20 to 40 μm, and more preferably of the order of 25 to 40 μm.

If the thickness of the charge transporting layer is less than 20 μm, an effect on light resistance may not be sufficient. If the thickness of the charge transporting layer is more than 40 μm, the electric properties may deteriorate.

### (2) Process Cartridge

The process cartridge according to the present disclosure characteristically comprises the photoreceptor according to the present disclosure and at least one selected from the electrifier for electrifying the photoreceptor, the developer for developing an electrostatic latent image formed by exposure to form a toner image, and the cleaner for removing a toner remaining on the photoreceptor.

For example, the process cartridge according to the present disclosure is configured to comprise: the photoreceptor according to the present disclosure; an electrifying device; a developing device; and a cleaning device, all of which are integrated on the supporting member. Incorporation of such a process cartridge into the image-forming apparatus 100 means that the image-forming apparatus 100 comprises each part as a constituent member of the process cartridge.

The process cartridge is detachable (removable) from the image-forming apparatus 100, making it easy to replace the process cartridge when being consumed (worn out).

### (3) Image-Forming Apparatus

The image-forming apparatus according to the present disclosure characteristically comprises at least the photoreceptor according to the present disclosure, the electrifier for electrifying the photoreceptor, the exposer for exposing the electrified photoreceptor to form an electrostatic latent image, the developer for developing the electrostatic latent image to form (visualize) a toner image, and the transferer for transferring the toner image onto a recording medium.

The image-forming apparatus according to the present disclosure may also be provided with a fuser for fusing the transferred toner image onto the recording medium to form an image, a cleaner for removing and recovering the toner remaining on the photoreceptor, and a charge eliminator for eliminating surface charges remaining on the photoreceptor.

The image-forming apparatus according to the present disclosure and operations thereof will be described below with reference to the drawings; however, the image-forming apparatus according to the present disclosure is not limited to the following descriptions.

FIG. 2 is a schematic side view showing a configuration of key components of the image-forming apparatus according to the present disclosure.

The image-forming apparatus (laser printer) 100 shown in FIG. 2 is configured to comprise a photoreceptor 1 according to the present disclosure, an exposer (semiconductor laser) 31, an electrifier (electrifying device) 32, a developer (developing device) 33, a transferer (transfer electrifying device) 34, a conveyor belt (not shown), a fuser (fusing device) 35, and a cleaner (cleaning device) 36. Reference numeral 51 denotes a recording medium (recording paper or transfer paper).

The photoreceptor 1 is rotatably supported by a main body of the image-forming apparatus 100 and rotationally driven around a rotation axis 44 in a direction of an arrow 41 by a driver (not shown in the drawings). The driver is configured to comprise, for example, an electric motor and a reduction gear and transmit its driving force to the conductive base constituting a core body of the photoreceptor 1, so that the photoreceptor 1 is rotationally driven at a predetermined peripheral velocity. The electrifier (electrifying device) 32, the exposer 31, the developer (developing device) 33, the transferer (transfer electrifying device) 34, and the cleaner (cleaning device) 36 are arranged in this order along an outer peripheral surface of the photoreceptor 1 from an upstream side to a downstream side in the rotation direction of the photoreceptor 1 indicated by the arrow 41.

The electrifying device 32 is an electrifier that uniformly electrifies the outer peripheral surface of the photoreceptor 1 at a predetermined potential.

The exposer 31 comprises a semiconductor laser as a light source and emits laser beam light output from the light source onto the surface of the photoreceptor 1 between the electrifying device 32 and the developing device 33, thereby applying exposure corresponding to image information onto the outer peripheral surface of the photoreceptor 1 electrified. The light beams repeatedly scan the outer peripheral surface of the photoreceptor 1 in an extending direction of the rotation axis 44 of the photoreceptor 1 as a main scanning direction, and these light beams form images, so that electrostatic latent images are sequentially formed on the surface of the photoreceptor 1. That means, the presence or absence of laser beam irradiation causes differences in electrification amounts of the photoreceptor 1 uniformly electrified by the electrifying device 32 so as to form the electrostatic latent images.

The developing device 33 is a developer that develops, using a developing powder (toner), the electrostatic latent image formed on the surface of the photoreceptor 1 by exposure, and is arranged facing the photoreceptor 1; and the developing device 33 comprises: a developing roller 33a for feeding the toner to the outer peripheral surface of the photoreceptor 1; and a casing 33b for supporting the developing roller 33a rotatably around a rotation axis parallel to the rotation axis 44 of the photoreceptor 1 and for accommodating the developing powder containing the toner in its own internal space.

The transfer electrifying device 34 is a transferer for transferring a toner image as a visible image formed on the outer peripheral surface of the photoreceptor 1 by development onto a transfer paper 51 that is a recording medium fed to between the photoreceptor 1 and the transfer electrifying device 34 from an arrow 42 direction by means of a conveyor (not shown in the drawings). The transfer electrifying device 34 is, for example, a contact-type transferer that comprises the electrifier and transfers a toner image onto the transfer paper 51 by applying a charge of the opposite polarity to the toner to the transfer paper 51.

The cleaner 36 is a clearing device for removing and recovering (collecting) the toner remaining on the outer peripheral surface of the photoreceptor 1 after the transfer operation using the transfer electrifying device 34, and comprises: a cleaning blade 36a for peeling off the toner remaining on the outer peripheral surface of the photoreceptor 1; and a recovery casing 36b for accommodating the toner peeled off by the cleaning blade 36a. The cleaner 36 is disposed together with a charge eliminating lamp, which is not shown in the drawings.

The image-forming apparatus 100 has the fusing device 35 as a fuser for fusing the transferred image, the fusing device 35 being placed on the downstream side to where the transfer paper 51, which has passed between the photoreceptor 1 and the transfer electrifying device 34, is conveyed. The fusing device 35 comprises: a heat roller 35a having a heater (not illustrated); and a pressure roller 35b arranged opposite to the heat roller 35a and pressed by the heat roller 35a to form a contact portion.

The reference numeral 37 indicates a separator that separates the transfer paper from the photoreceptor, and the reference numeral 38 indicates a casing that accommodates each of the above-mentioned components in the image-forming apparatus.

The image-forming operations by the image-forming apparatus 100 are performed as follows. First, once the photoreceptor 1 is rotationally driven in the direction of the arrow 41 by the driver, the surface of the photoreceptor 1 is uniformly electrified (charged) at a predetermined positive potential by the electrifying device 32 provided upstream in the rotational direction of the photoreceptor 1 from a point of the image formation by light to be emitted from the exposer 31.

Subsequently, the exposer 31 emits light according to the image information toward the surface of the photoreceptor 1. In the photoreceptor 1, surface charges of a part irradiated with the light are removed by this exposure, causing a difference between a surface potential of the part irradiated with the light and a surface potential of a part not irradiated with the light to form an electrostatic latent image.

The developing device 33 disposed on the downstream side in the rotational direction of the photoreceptor 1 from the point of the image formation by the light emitted from the exposer 31 supplies a toner to the surface of the photoreceptor 1 on which an electrostatic latent image is formed, and then the electrostatic latent image is developed to form a toner image.

A transfer paper 51 is fed to between the photoreceptor 1 and the transfer electrifying device 34 in synchronization with the exposure to the photoreceptor 1. A charge that is opposite in polarity to the toner is applied to the fed transfer paper 51 by the transfer electrifying device 34, so that the toner image formed on the surface of the photoreceptor 1 is transferred onto the transfer paper 51.

The transfer paper 51, to which the toner image is transferred, is conveyed to the fusing device 35 by the conveyor and is heated and pressurized while passing through a contact portion between the heat roller 35a and the pressure roller 35b of the fusing device 35; and the toner image is fused to the transfer paper 51 to obtain a robust image. The transfer paper 51 on which the image is formed in this way is discharged to the outside of the image-forming apparatus 100 by the conveyor.

The toner remaining on the surface of the photoreceptor 1 even after the transfer of the toner image by the transfer electrifying device 34 is peeled off from the surface of the photoreceptor 1 and recovered by the cleaning device 36. The charges on the surface of the photoreceptor 1 from which the toner has been removed in this way are removed by light from a charge eliminating lamp, and the electrostatic latent image on the surface of the photoreceptor 1 disappears. After that, the photoreceptor 1 is further rotationally driven, and a series of the operations starting from the electrification are repeated to continuously form images.

The above-described image-forming apparatus 100 is a monochrome image-forming apparatus (printer); however, this may also be, for example, an intermediate transfer-type color image-forming apparatus capable of forming color images. Specifically, this may be a so-called tandem-type full-color image-forming apparatus having a structure in which a plurality of electrophotographic photoreceptors are arranged side by side in a predetermined direction (for example, a horizontal direction H or an abbreviated horizontal direction H), each of which forms a toner image. The image-forming apparatus 100 may also be other color image-forming apparatuses, a copier, a multifunction peripheral, or a facsimile machine.

### EXAMPLES

Hereinafter, the present disclosure will be specifically described as Examples and Comparative Examples; however, these Examples do not limit the present invention as long as the Examples do not go beyond the essential contents of the present invention. In the Examples and the Comparative Examples, a laminated photoreceptor with a laminated photoreceptive layer was employed; however, the same effects can be obtained by using a single-layer photoreceptor with a single-layer photoreceptive layer.

In the Examples and the Comparative Examples, physical properties of materials used were measured by the following methods.

### (1) Maximum Absorption Wavelength Amax of Electron Transporting Substance

The electron transporting substance is measured for a spectral absorption spectrum in a wavelength range from 400 to 900 nm by using a UV-visible spectrophotometer (UV-VIS SPECTROPHOTOMETER; model: UV-2450, manufactured by Shimadzu Corporation), provided that a maximum value in wavelengths of 500 to 600 nm is considered a maximum absorption wavelength λₘₐₓ.

### (2) Average Primary Particle Diameter of Silica Filler

Using a scanning electron microscope (SEM; model: S-4800, manufactured by Hitachi High-Tech Corporation), silica particles are photographed at a magnification of 30,000 to 300,000 times, for example, 100,000 times; and any one hundred (100) silica particles photographed in an image obtained are observed as primary particles; and then an average particle diameter (long diameter) in the Feret direction is calculated by an image analysis, making it as an average primary particle diameter (nm).

### Example 1

### Formation of Undercoat Layer

3 parts by mass of titanium oxide (product name: TIPAQUE TTO-D-1, manufactured by ISHIHARA SANGYO KAISHA, LTD.) and 2 parts by mass of a copolymerized polyamide (nylon) (product name: Amilan (registered trademark); grade: CM8000, manufactured by Toray Industries, Inc.) were added to 25 parts by mass of methyl alcohol and were then dispersed therein by a paint shaker for 8 hours to prepare 3 litters of an undercoat layer coating liquid.

A bath was filled with the undercoat layer coating liquid obtained above; and an aluminum drum-shaped base having a diameter of 30 mm and a length of 255 mm as a conductive base F1 was immersed into the coating liquid and then was pulled up. A coating film (or simply a film) thereby obtained was dried naturally to form an undercoat layer F21 having a thickness of 1 μm on the conductive base F1.

### Formation of Charge Generating Layer

Titanyl phthalocyanine represented by a structural formula of FIG. 13 was prepared in advance, which was to be used as a charge generating substance.

29.2 g of diiminoisoindoline was mixed with 200 ml of sulfolane; and 17.0 g of titanium tetraisopropoxide was then added to the mixture; and the resulting mixture was allowed to react under nitrogen atmosphere at 140° C. for 2 hours. The reaction mixture thereby obtained was left to cool; and then a precipitate was filtered off, washed with chloroform and 2% aqueous hydrochloric acid solution in this order, further washed with water and methanol in this order, and then dried to obtain 25.5 g of blue-violet crystal.

As a result of chemical analysis of the compound obtained, the compound was confirmed to be titanyl phthalocyanine represented by the above structural formula (yield: 88.5%). 1 part by mass of the obtained titanyl phthalocyanine and 1 part by mass of a butyral resin (product name: S-LEC BM-2, manufactured by SEKISUI CHEMICAL CO., LTD.) were added to 98 parts by mass of methylethylketone and were dispersed therein by a paint shaker for 2 hours to prepare 3 litters of a charge generating layer coating liquid.

The thereby-obtained charge generating layer coating liquid was applied onto the undercoat layer F21 in the same immersion technique as in the formation of the undercoat layer; and a coating film thereby obtained was dried naturally to form a charge generating layer F22 having a thickness of 0.3 μm.

### Formation of Charge Transporting Layer

3.4 g of a silica filler (average primary particle diameter of 16 nm; subjected to a dimethylchlorosilane surface treatment; product name: AEROSIL (registered trademark) R972, manufactured by NIPPON AEROSIL CO., LTD.) was added to 30.3 g of tetrahydrofuran, suspended, and stirred for 30 hours. To the resulting silica filler suspension, 10.0 g of compound 2-1 (stilbene derivative) represented by the structural formula of FIG. 10 as the hole transporting substance, 0.30 g of tribenzylamine (manufactured by Tokyo Chemical Industry Co., Ltd.) as the antioxidant, 19.0 g of polycarbonate (product name: TS2050, manufactured by Teijin Chemicals Limited), 1.0 g of compound 1-1 (λₘₐₓ=528 nm) represented by the structural formula of FIG. 4 (wherein Ph denotes a phenyl group) as the electron transporting substance, and 104.4 g of tetrahydrofuran were added and mixed:

The resulting mixture was stirred for 5 minutes using an ultra-atomization apparatus (product name: Damatorisystem, manufactured by YOSHIDA KIKAI CO., LTD.) and then subjected to 10-pass dispersion using a particle dispersing apparatus (model: Microfluitizer M-110P, manufactured by Microfluidics Corporation) to prepare 168.3 g of a charge transporting layer coating liquid.

The thereby-obtained charge transporting layer coating liquid was applied onto the charge generating layer F22 in the same immersion technique as in the formation of the undercoat layer; and a coating film thereby obtained was dried at a temperature of 115° C. for 1.5 hours to form a charge transporting layer F23 having a thickness of 35 μm, thereby preparing a photoreceptor F01 of Example 1 shown in FIG. 1.

The above-mentioned compound 1-1 was prepared in advance in accordance with the method described in Japanese Patent No. 4041741, and the above-mentioned compound 2-1 (stilbene derivative) was prepared in advance in accordance with the method described in Japanese Patent No. 3272257.

### Example 2

In the preparation of the charge transporting layer coating liquid, a photoreceptor of Example 2 was prepared in the same way as in Example 1, except that compound 1-2 (λₘₐₓ=510 nm) represented by the structural formula of FIG. 5 was used instead of compound 1-1 as the electron transporting substance.

The above-mentioned compound 1-2 was prepared in advance in accordance with the method described in Japanese Patent No. 4041741.

### Example 3

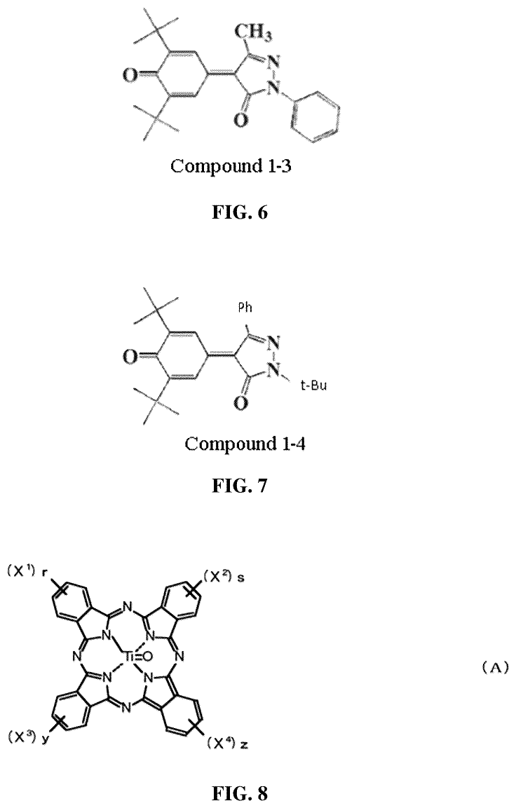

In the preparation of the charge transporting layer coating liquid, a photoreceptor of Example 3 was prepared in the same way as in Example 1, except that compound 1-3 (λₘₐₓ=580 nm) represented by the structural formula of FIG. 6 was used instead of compound 1-1 as the electron transporting substance.

The above-mentioned compound 1-3 was prepared in advance in accordance with the method described in Japanese Patent No. 4041741.

### Example 4

In the preparation of the charge transporting layer coating liquid, a photoreceptor of Example 4 was prepared in the same way as in Example 1, expect that the following ingredients were used: 2.24 g of the silica filler (average primary particle diameter of 40 nm; subjected to a hexamethyldisilazane surface treatment; product name: AEROSIL (registered trademark) RX-50, manufactured by NIPPON AEROSIL CO., LTD.); 29.8 g of tetrahydrofuran for the suspension; 0.45 g of the electron transporting substance to be added to the suspension; and 98.2 g of tetrahydrofuran to be added to the suspension.

### Example 5

In the preparation of the charge transporting layer coating liquid, a photoreceptor of Example 5 was prepared in the same way as in Example 1, except that the blending amount of the silica filler was changed to 6.21 g; and the blending amount of tetrahydrofuran to be added to the suspension was changed to 115.7 g.

### Example 6

In the preparation of the charge transporting layer coating liquid, a photoreceptor of Example 6 was prepared in the same way as in Example 1, except that the amount of the silica filler (average primary particle diameter of 12 nm; subjected to a dimethylchlorosilane surface treatment; product name: AEROSIL (registered trademark) R974, manufactured by NIPPON AEROSIL CO., LTD.) was changed to 2.64 g; the blending amount of tetrahydrofuran for the suspension was changed to 30.4 g; the blending amount of the electron transporting substance to be added to the suspension was changed to 1.10 g; and the amount of tetrahydrofuran to be added to the suspension was changed to 101.8 g.

### Example 7

In the preparation of the charge transporting layer coating liquid, a photoreceptor of Example 7 was prepared in the same way as in Example 1, except that the blending amount of the silica filler was changed to 3.68 g; the blending amount of tetrahydrofuran for the suspension was changed to 29.8 g; the addition amount of the electron transporting substance to be added to the suspension was changed to 0.50 g; and the blending amount of tetrahydrofuran to be added to the suspension was changed to 104.13 g.

### Example 8

In the preparation of the charge transporting layer coating liquid, a photoreceptor of Example 8 was prepared in the same way as in Example 1, except that the amount of the silica filler (average primary particle diameter of 12 nm; subjected to a dimethylchlorosilane surface treatment; product name: AEROSIL (registered trademark) R974, manufactured by NIPPON AEROSIL CO., LTD.) was changed to 2.59 g; the blending amount of tetrahydrofuran for the suspension was changed to 29.8 g; the blending amount of the electron transporting substance to be added to the suspension was changed to 0.50 g; and the blending amount of tetrahydrofuran to be added to the suspension was changed to 99.77 g.

### Example 9

In the preparation of the charge transporting layer coating liquid, a photoreceptor of Example 9 was prepared in the same way as in Example 1, except that the amount of the silica filler (average primary particle diameter of 30 nm; subjected to a hexamethyldisilazane surface treatment; product name: AEROSIL (registered trademark) NAX-50, manufactured by NIPPON AEROSIL CO., LTD.) was changed to 6.29 g; the blending amount of tetrahydrofuran for the suspension was changed to 30.7 g; the blending amount of the electron transporting substance to be added to the suspension was changed to 1.40 g; and the blending amount of tetrahydrofuran to be added to the suspension was changed to 117.3 g.

### Example 10

In the preparation of the charge transporting layer coating liquid, a photoreceptor of Example 10 was prepared in the same way as in Example 1, except that the following blending amounts were used: 1.58 g of the silica filler; 30.0 g of tetrahydrofuran for the suspension; 0.70 g of the electron transporting substance to be added to the suspension; and 96.3 g of tetrahydrofuran to be added to the suspension.

### Example 11

In the preparation of the charge transporting layer coating liquid, a photoreceptor of Example 11 was prepared in the same way as in Example 1, except that the amount of the silica filler (average primary particle diameter of 30 nm; subjected to a hexamethyldisilazane surface treatment; product name: AEROSIL (registered trademark) NAX-50, manufactured by NIPPON AEROSIL CO., LTD.) was changed to 10.1 g; and the blending amount of tetrahydrofuran to be added to the suspension was changed to 131.3 g.

### Example 12

In the preparation of the charge transporting layer coating liquid, a photoreceptor of Example 12 was prepared in the same way as in Example 1, except that the amount of the silica filler (average primary particle diameter of 30 nm; subjected to a hexamethyldisilazane surface treatment; product name: AEROSIL (registered trademark) NAX-50, manufactured by NIPPON AEROSIL CO., LTD.) was changed to 2.21 g; the blending amount of tetrahydrofuran for the suspension was changed to 29.5 g; the blending amount of the electron transporting substance to be added to the suspension was changed to 0.18 g; and the blending amount of tetrahydrofuran to be added to the suspension was changed to 97.3 g.

### Example 13

In the preparation of the charge transporting layer coating liquid, a photoreceptor of Example 13 was prepared in the same way as in Example 1, except that the amount of the silica filler (average primary particle diameter of 12 nm; subjected to a dimethylchlorosilane surface treatment; product name: AEROSIL (registered trademark) R974, manufactured by NIPPON AEROSIL CO., LTD.) was changed to 8.00 g; the blending amount of tetrahydrofuran for the suspension was changed to 32.0 g; the blending amount of the electron transporting substance to be added to the suspension was changed to 2.70 g; and the blending amount of tetrahydrofuran to be added to the suspension was changed to 128.00 g.

### Example 14

In the preparation of the charge transporting layer coating liquid, a photoreceptor of Example 14 was prepared in the same way as in Example 1, except that the amount of the silica filler (average primary particle diameter of 7 nm; subjected to a dimethylchlorosilane surface treatment; product name: AEROSIL (registered trademark) R976, manufactured by NIPPON AEROSIL CO., LTD.) was changed to 3.39 g; the blending amount of tetrahydrofuran for the suspension was changed to 30.5 g; the blending amount of the electron transporting substance to be added to the suspension was changed to 1.20 g; and the blending amount of tetrahydrofuran to be added to the suspension was changed to 105.06 g.

### Example 15

In the preparation of the charge transporting layer coating liquid, a photoreceptor of Example 15 was prepared in the same way as in Example 1, except that the amount of the silica filler (average primary particle diameter of 100 nm; subjected to a hexamethyldisilazane surface treatment; product name: AEROSIL (registered trademark) VPRX-40, manufactured by NIPPON AEROSIL CO., LTD.) was changed to 7.45 g; the blending amount of tetrahydrofuran for the suspension was changed to 29.8 g; the blending amount of the electron transporting substance to be added to the suspension was changed to 0.50 g; and the blending amount of tetrahydrofuran to be added to the suspension was changed to 119.20 g.

### Example 16

In the preparation of the charge transporting layer coating liquid, a photoreceptor of Example 16 was prepared in the same way as in Example 1, except that compound 1-4 (λₘₐₓ=553 nm) represented by the structural formula of FIG. 7 was used instead of compound 1-1 as the electron transporting substance.

The above-mentioned compound 1-4 was prepared in advance in accordance with the method described in Japanese Patent No. 4041741. In the formula, Ph denotes a phenyl group; and t-Bu denotes a tert-butyl group.

### Example 17

In the preparation of the charge transporting layer coating liquid, a photoreceptor of Example 17 was prepared in the same way as in Example 1, except that the silica filler was changed to a silica filler (average primary particle diameter of 16 nm; subjected to a hexamethyldisilazane surface treatment; product name: AEROSIL (registered trademark) NX130, manufactured by NIPPON AEROSIL CO., LTD.).

### Example 18

In the preparation of the charge transporting layer coating liquid, a photoreceptor of Example 18 was prepared in the same way as in Example 1, except that the following blending amounts were used: 3.86 g of the silica filler; 31.2 g of tetrahydrofuran for the suspension; 1.92 g of the electron transporting substance to be added to the suspension; and 109.10 g of tetrahydrofuran to be added to the suspension.

### Example 19

In the preparation of the charge transporting layer coating liquid, a photoreceptor of Example 19 was prepared in the same way as in Example 1, except that the amount of the silica filler (average primary particle diameter of 12 nm; subjected to a dimethylchlorosilane surface treatment; product name: AEROSIL (registered trademark) R974, manufactured by NIPPON AEROSIL CO., LTD.) was changed to 3.11 g; the blending amount of tetrahydrofuran for the suspension was changed to 29.8 g; the blending amount of the electron transporting substance to be added to the suspension was changed to 0.53 g; and the blending amount of tetrahydrofuran to be added to the suspension was changed to 102.75 g.

### Comparative Example 1

In the preparation of the charge transporting layer coating liquid, a photoreceptor of Comparative Example 1 was prepared in the same way as in Example 1, except that the following ingredients were used: 2.87 g of the silica filler; 30.9 g of tetrahydrofuran for the suspension; 1.60 g of the electron transporting substance to be added to the suspension; and 104.18 g of tetrahydrofuran to be added to the suspension.

### Comparative Example 2

In the preparation of the charge transporting layer coating liquid, a photoreceptor of Comparative Example 2 was prepared in the same way as in Example 1, except that the amount of the silica filler (average primary particle diameter of 12 nm; subjected to a dimethylchlorosilane surface treatment; product name: AEROSIL (registered trademark) R974, manufactured by NIPPON AEROSIL CO., LTD.) was changed to 7.62 g; the blending amount of tetrahydrofuran for the suspension was changed to 30.5 g; the blending amount of the electron transporting substance to be added to the suspension was changed to 1.17 g; and the blending amount of tetrahydrofuran to be added to the suspension was changed to 121.88 g.

### Comparative Example 3

In the preparation of the charge transporting layer coating liquid, a photoreceptor of Comparative Example 3 was prepared in the same way as in Example 1, except that the silica filler was not used; and the following ingredients were added to 107.4 g of tetrahydrofuran as the solvent and mixed: 10.0 g of compound 2-1 as the hole transporting substance; 0.30 g of tribenzylamine (product name: tribenzylamine, manufactured by Tokyo Chemical Industry Co., Ltd.) as the antioxidant; 19.0 g of polycarbonate (product name: TS2050, manufactured by Teijin Chemicals Limited); and 1.0 g of compound 1-1 as the electron transporting substance; and the mixture was stirred for 30 hours.

### Comparative Example 4

In the preparation of the charge transporting layer coating liquid, a photoreceptor of Comparative Example 4 was prepared in the same way as in Example 1, except that the blending amount of the silica filler was changed to 3.26 g; the blending amount of tetrahydrofuran for the suspension was changed to 29.3 g; the electron transporting substance was not added to the suspension; and the blending amount of tetrahydrofuran to be added to the suspension was changed to 100.92 g.

### Comparative Example 5

In the preparation of the charge transporting layer coating liquid, a photoreceptor of Comparative Example 5 was prepared in the same way as in Example 1, except that a dye C.I. Solvent Red 52 (λₘₐₓ=540 nm; product name: KP Plast Red 5B, manufactured by Kiwa Chemical Industry Co., Ltd.) was used as the electron transporting substance.

### Comparative Example 6

In the preparation of the charge transporting layer coating liquid, a photoreceptor of Comparative Example 6 was prepared in the same way as in Example 1, except that the blending amount of the silica filler was changed to 3.30 g; the blending amount of tetrahydrofuran for the suspension was changed to 29.7 g; 0.40 g of a dye C.I. Solvent Red 52 (λₘₐₓ=540 nm; product name: KP Plast Red 5B, manufactured by Kiwa Chemical Industry Co., Ltd.) was used as the electron transporting substance; and the blending amount of tetrahydrofuran to be added to the suspension was changed to 102.30 g.

### Evaluations

As will be described in the following items, the photoreceptors prepared in Examples 1 to 19 and Comparative Examples 1 to 6 were evaluated.

For evaluations (1) and (2) to be described below, the above-prepared photoreceptors were each installed in a unit of a digital copier (model: MX-B455W, manufactured by SHARP CORPORATION) remodeled for testing and were evaluated.

### (1) Light Resistance

The two photoreceptors of the Examples and the Comparative Examples each to be evaluated were respectively exposed to fluorescent light of 1,000 Lux for 10 min and fluorescent light of 400 Lux for 20 min, and effects on images after 1 min were evaluated. Exposed areas and non-exposed areas were visually compared so as to evaluate for light resistance on the following criteria.

### Evaluation Criteria

VG: No effect on images was observed under both the exposure conditions.
G: Minor image defects were observed with the 1,000 Lux exposure, whereas there were no problems with the 400 Lux exposure with no effect on images observed.
NB: Minor image defects were observed even with the 400 Lux exposure, but no problems in actual use.
B: Obvious image defects were observed after the exposures.
   (2) Recovery (Recoverability) from Light Damages

After evaluation (1) was performed, the photoreceptors were left in a dark place for 10 min and were evaluated for effect on images in the same way as in the above-described (1). The exposed areas were visually compared with the non-exposed areas to evaluate for light resistance (recovery from light damages) on the following criteria.

### Evaluation Criteria

VG: No effect on images was observed under both the exposure conditions.
G: Minor image defects were observed with the 1,000 Lux exposure after the photoreceptors were left in the dark place for 10 min, whereas there were no problems with the 400 Lux exposure with no effect on images observed after the photoreceptors were left in the dark place for 10 min.
NB: Minor image defects were observed even with the 400 Lux exposure after the photoreceptors were left in the dark place for 10 min, but no problems in actual use.
B: After the exposures, obvious image defects were confirmed (observed) even after the photoreceptors were left in the dark place for 10 min.

### (3) Sensitivity Stability

The photoreceptors separately prepared to be evaluated were each installed in a unit of a digital copier (model: BP-40C26, manufactured by SHARP CORPORATION) remodeled for testing; and the developing device was removed from the digital copier; instead of the developing device, a surface electrometer (model: MODEL 344, manufactured by Trek Japan K.K.) was attached at a developing site of the digital copier. Under an environment of a temperature of 25° C. and a relative humidity of 50%, an initial residual potential and a surface potential of the photoreceptors after current fatigue were measured; and these differences ΔVr (V) were used as evaluation criteria, which will be described below, to evaluate sensitivity stability of the photoreceptors as an index of sensitivity deterioration caused by repeated use.

### Evaluation Criteria

VG: ΔVr<40

The photoreceptors can be used without any problem even in a high-speed multifunction peripheral or printer that are required to have high sensitivity.
G: 40≤ΔVr<80

The photoreceptors can be used without any problem in a low-speed to middle-speed multifunction peripheral or printer.
NB: 80≤ΔVr<140

The photoreceptors can be used without any problem, despite having a slightly low density, in a low-speed and low-price multifunction peripheral or printer.
B: 140≤ ΔVr

Due to poor sensitivity, density was low, which is problematic in actual use.

### (4) Printing Durability

The photoreceptors separately prepared to be evaluated were each installed in a unit of a digital copier (model: BP-40C26, manufactured by SHARP CORPORATION) remodeled for testing; a developing device was attached; and the pressure at which the cleaning blade of the cleaner contacts the photoreceptor—a so-called cleaning blade pressure—was adjusted to 21 gf/cm (2.05×10⁻¹ N/cm: initial linear pressure). A printing durability test was conducted by printing a character test chart (ISO 19752) on 200,000 sheets of recording paper under an environment of a temperature of 25° C. and a relative humidity of 85%.

A thickness of the photoreceptive layers each was measured at the start of the printing durability test and after the image formation on the 200,000 sheets of recording paper by using a film thickness measurement instrument (model: F20-EXR, manufactured by Filmetrics, Inc.).

From the difference between the thickness of the photoreceptive layer at the start of the printing durability test and the thickness thereof after the image formation on the 200,000 sheets of recording paper, an amount of film loss per 100,000 rotations of the photoreceptor drum was determined; and the printing durability was evaluated from the obtained film loss amount on the following criteria.

It was evaluated that the greater the film loss amount, the worse the printing durability.

### Evaluation Criteria

VG: film loss amount<0.50 μm/100,000 revolutions

The photoreceptors can be used without any problem even in a multifunction peripheral or a printer that are required to have long life.
G: 0.50 μm/100,000 revolutions≤film loss amount<0.70 μm/100,000 revolutions

The photoreceptors can be used without any problem despite having a slightly high amount of film loss, as long as being used in a multifunction peripheral or a printer that are not required to have long life.
NB: 0.70 μm/100,000 revolutions≤film loss amount<0.85 μm/100,000 revolutions

The photoreceptors can be used without any problem despite having a high amount of film loss, as long as being used in a low-price multifunction peripheral or printer.
B: 0.85 μm/100,000 revolutions≤film loss amount

Problematic in actual use because of a high amount of film loss

### Overall Evaluation

Based on the results of the above evaluations (1) through (4), if there was no “B” in any of the four items, the photoreceptors were evaluated as “usable”; and if at least one of the four items had a “B”, the photoreceptors were evaluated as “not usable”.

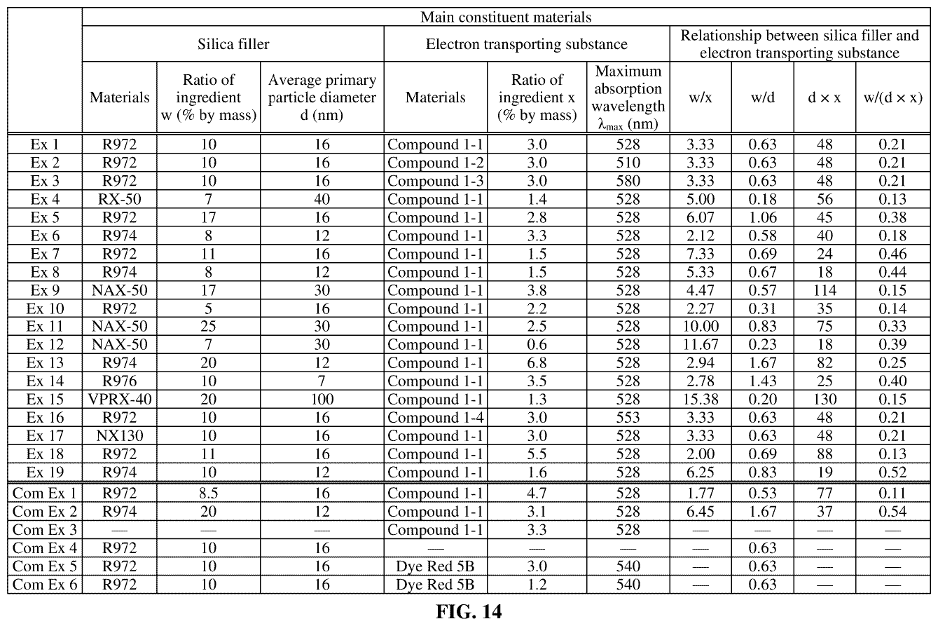

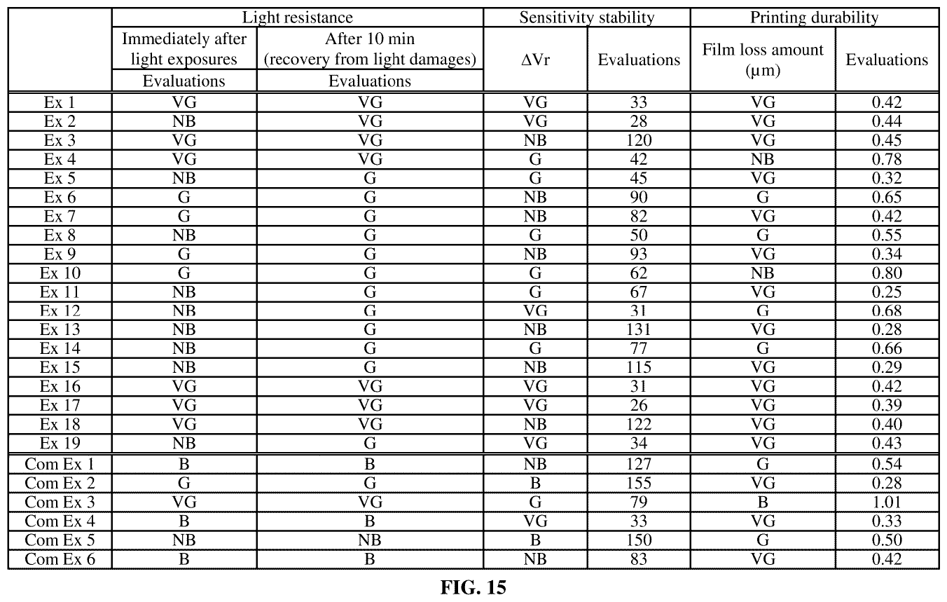

The main constituent materials used in the preparation of the photoreceptors in Examples and Comparative Examples, their contents, and their relationship are shown in FIG. 14, and the evaluation results of the obtained photoreceptors are shown in FIG. 15.

In FIG. 14, the silica fillers are denoted by their alphanumeric product names or parts thereof; and the electron transporting substances are denoted by compounds 1-1 through 1-4.

In FIG. 14 and FIG. 15, “Ex” indicates Examples, and “Com Ex” indicates Comparative Examples.

The following were found from the results shown in FIGS. 14 and 15:
(1) The photoreceptors with the constituent features of the present disclosure (Examples 1 to 19) were excellent in any of light resistance, recovery from light damages, sensitivity stability, and printing durability.
(2) When the relationship w/(d×x) between the silica filler content w and the average primary particle diameter d of the silica filler and the electron transporting substance content x was less than 0.12 (Comparative Example 1), w became too large relative to (d×x), resulting in poor potential stability. When w/(d×x) exceeded 0.54 (Comparative Example 2), w became too small relative to (d×x), and the amount of the electron transporting substance added became too small relative to the added amount and the average primary particle diameter of the silica filler. As a result, desired light resistance and recovery from light damages were not obtained.
(3) Deterioration of potential stability was observed in Example 18 although it was not at a level to cause problems in actual use, and weakness against light damages was observed in Example 19 although it was not at a level to cause problems in actual use. As a result, a range of 0.12<w/(x×d)<0.54 was found to be preferable.
(4) When the photoreceptive layer did not contain the silica filler (Comparative Example 3), desired printing durability was not obtained. As a result, the silica filler was an essential ingredient of the photoreceptive layer.
(5) When the dye that absorbs light wavelengths of fluorescent lamps was added, instead of the electron transporting substance of the present disclosure, to the photoreceptive layer, a certain effect was observed with respect to light resistance due to a light shielding effect, while no effect was observed with respect to recovery from light damages; and when an amount of the dye that shows an effect of light resistance was added to the photoreceptive layer, sensitivity stability could not be ensured (Comparative Example 5). When the dye content was reduced in order to ensure certain sensitivity stability, light resistance deteriorated, causing problems in actual use (Comparative Example 6). As a result, the electron transporting substance of the present disclosure was an essential ingredient of the Attorney Docket No.: US91676 photoreceptive layer.
(6) When the electron transporting substance with a short maximum absorption wavelength λₘₐₓ was used, an effect of light resistance became less, thereby making it necessary to select a material that sufficiently blocks wavelength ingredients around a wavelength of 550 nm (Example 2); and when the electron transporting substance with a long maximum absorption wavelength λₘₐₓ was used, sensitivity stability became poor, thereby making it necessary to select a material that does not block too much light wavelength ingredients around a wavelength of 600 nm (Example 3).
(7) Equivalent effects were obtained with materials that had a good balance of blocking wavelengths near 500 nm/600 nm (Example 16), and equivalent effects were obtained even when the silica surface was treated differently (Example 17).

What is claimed is:

1. An electrophotographic photoreceptor comprising at least a photoreceptive layer on a conductive base,
wherein the photoreceptive layer contains a silica filler and an electron transporting substance represented by general formula (I): 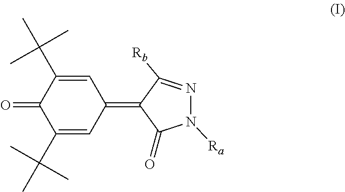
wherein Rₐ and R_{b} are identically or independently a hydrogen atom, a halogen atom, a cyano group, a nitro group, a hydroxyl group, an alkyl group having 1 to 12 carbon atoms, an alkoxy group having 1 to 12 carbon atoms, an aryl group that may have a substituent, a heterocyclic group that may have a substituent, an ester group, a cycloalkyl group, an aralkyl group that may have a substituent, an allyl group, an amide group, an amino group, an acyl group, an alkenyl group, an alkynyl group, a carboxyl group, a carbonyl group, a carboxylic group, or an alkyl halide group; and the substituents each are a halogen atom, an alkyl group having 1 to 6 carbon atoms, an alkoxy group having 1 to 6 carbon atoms, a hydroxyl group, a cyano group, an amino group, a nitro group, or an alkyl halide group; and
wherein when a content of the silica filler to a total solid content of the photoreceptive layer is denoted by w (% by mass), when an average primary particle diameter of the silica filler is denoted by d (nm), and when a content of the electron transporting substance to the total solid content of the photoreceptive layer is denoted by x (% by mass), the electrophotographic photoreceptor satisfies the following relationship:
$$\\ 0.12 < w / ( d \times x ) < 0.54 .$$

2. The electrophotographic photoreceptor according to claim 1, wherein the electron transporting substance has a maximum absorption wavelength λₘₐₓ at wavelengths of 515 to 560 nm.

3. The electrophotographic photoreceptor according to claim 1, wherein the electron transporting substance is characterized in that the substituent R_{b} in the above general formula (I) represents an aryl group that may have a substituent, wherein the substituent is a halogen atom, an alkyl group having 1 to 6 carbon atoms, an alkoxy group having 1 to 6 carbon atoms, a hydroxyl group, a cyano group, an amino group, a nitro group, or an alkyl halide group.

4. The electrophotographic photoreceptor according to claim 3, wherein the electron transporting substance is characterized in that the substituents Rₐ and R_{b} in the above general formula (I) are each an aryl group that may have a substituent.

5. The electrophotographic photoreceptor according to claim 1, wherein the photoreceptive layer is a laminated photoreceptive layer comprising: a charge generating layer containing a charge generating substance; and a charge transporting layer containing a charge transporting substance.

6. The electrophotographic photoreceptor according to claim 1, wherein the ratio w/d between the content w of the silica filler to the total solid content of the photoreceptive layer and the average primary particle diameter d of the silica filler is in a range from 0.20 to 0.95.

7. The electrophotographic photoreceptor according to claim 1, wherein the ratio w/x between the content w of the silica filler to the total solid content of the photoreceptive layer and the content x of the electron transporting substance to the total solid content of the photoreceptive layer is in a range from 2.2 to 8.0.

8. The electrophotographic photoreceptor according to claim 1, wherein the value d×x, which is obtained by multiplying the average primary particle diameter d of the silica filler by the content x of the electron transporting substance to the total solid content of the photoreceptive layer, is in a range from 20 to 110.

9. The electrophotographic photoreceptor according to claim 1, wherein the silica filler is contained in the photoreceptive layer at a ratio of 7 to 20% by mass to the total solid content of the photoreceptive layer.

10. The electrophotographic photoreceptor according to claim 1, wherein the electron transporting substance is contained in the photoreceptive layer at a ratio of 0.65 to 6.5% by mass to the total solid content of the photoreceptive layer.

11. The electrophotographic photoreceptor according to claim 1, wherein the silica filler has an average primary particle diameter of 10 to 40 nm.

12. A process cartridge comprising the electrophotographic photoreceptor according to claim 1 and at least one selected from an electrifier for electrifying the electrophotographic photoreceptor, a developer for developing an electrostatic latent image formed by exposure to form a toner image, and a cleaner for removing a toner remaining on the electrophotographic photoreceptor.

13. An image-forming apparatus comprising at least the electrophotographic photoreceptor according to claim 1, an electrifier for electrifying the electrophotographic photoreceptor, an exposer for exposing the electrified electrophotographic photoreceptor to form an electrostatic latent image, a developer for developing the electrostatic latent image to form a toner image, and a transferer for transferring the toner image onto a recording medium.
